(19) United States
(12) Patent Application Publication
(10) Pub. No.: US 2014/0161343 A1
(43) Pub. Date: Jun. 12, 2014

(54) INSPECTION UNIT

(71) Applicant: KHS GmbH, Dortmund (DE)

(72) Inventors: Katrin Preckel, Gelsenkirchen (DE); Michael Nick, Dortmund (DE); Werner Van de Wynckel, Wolvertem (BE)

(73) Assignee: KHS GmbH, Dortmund (DE)

(21) Appl. No.: 14/235,516

(22) PCT Filed: Jul. 7, 2012
(86) PCT No.: PCT/EP2012/002875

§ 371 Date: Jan. 28, 2014

(30) Foreign Application Priority Data
Jul. 28, 2011 (DE) 10 2011 108 754.4

(51) Int. Cl. G06T 7/00

(52) U.S. Cl. CPC G06T 7/001
USPC 382/142

(57) ABSTRACT

A method for processing a container includes inspecting it by using an optical recorder of an inspection unit, capturing container image data representative of actual images, sending it to an evaluation and control unit of the inspection unit having a main processor and a graphics card having graphics processors, using the graphics card, comparing the actual images with desired images at least in part by using the graphics processors for pipelining calculations associated with the comparison, and then finally, using the graphics card, sending evaluated data representative of the comparison to the main processor.

### RELATED APPLICATIONS

This application is a national stage entry under §371 of PCT/EP2012/002875, filed on Jul. 7, 2012, which claims the benefit of the Jul. 28, 2011 priority date of German application DE 10 2011 108 754.4. The contents of the foregoing applications are incorporated herein by reference.

### FIELD OF DISCLOSURE

The present invention is directed to a device for the inspection of containers and to a method for inspection.

### BACKGROUND

Containers are generally not labeled directly. In most cases, containers are labeled indirectly, by applying preprinted labels.

Conventional preprinted labels undergo a number of production steps. For example, labels are first printed with test strips from which the print quality of the entire quantity of goods of a cohesive production process, i.e. a batch, can be reliably inspected. It is only in a subsequent step that the individual labels are cut to size and applied to the bottle.

Compared with glued preprinted labels, labels directly printed containers offer flexibility in their design options, for example in the case of rapid product changeovers, market launches and special editions or personalized product solutions. Directly printed bottles are produced “just-in-sequence.” There are no intermediate steps in which errors for an entire series of products can be eliminated. Through the direct printing of containers, it is possible to vary the layout of the printing from container to container. As a result, any error analysis for detecting printing errors also has to be designed to accommodate changing design patterns.

It would therefore be desirable to be able to locate a faulty container as quickly and efficiently as possible by way of a device for inspection and a method for inspection so as to then be able to remove the faulty container from the production process as quickly as possible.

### SUMMARY

To this end the present invention proposes a method that facilitates a rapid inspection of a container during the production process. Also proposed are a corresponding device and a computer program product with program code stored on a computer-readable data medium that facilitates a realization of an inventively proposed method for the effective inspection of a container.

The dependent claims respectively describe further details of possible embodiments of the proposed method and/or of the proposed device.

According to one embodiment, an inventive device for the inspection of containers comprises at least one storage module for desired images, at least one optical recording unit for generating actual images of at least one container that is to be inspected, and an evaluation-and-control unit, with the evaluation-and-control unit comprising at least one main processor and at least one graphics card. The at least one graphics card comprises at least two graphics processors and supports graphics card programming for the swapping out of calculations, which are associated with a comparison of actual with desired images, to the graphics processors.

GPGPU, which stands for “General Purpose Computation on Graphics Processing Unit,” refers to the use of a graphics processor for calculations over and above its original remit. This could, for example, be calculations for technical or commercial simulations. In the case of parallel algorithms, a huge increase in speed over the main processor can be achieved in this way.

GPGPU has emerged from the shaders of graphics processors. Shaders are hardware or software modules that implement certain rendering effects in 3D computer graphics. Their strength lies in the simultaneous performing of uniform tasks such as the rendering of pixels or the multiplication of large matrices. Since the growth in the speed of modern processors can no longer be achieved by increasing the clock pulse, pipelining is an important factor in achieving higher computing powers of modern computers. The advantage of using the GPU instead of the CPU lies in the greater computing power and the higher memory bandwidth. The speed is achieved mainly through the high degree of parallelism of the computing operations of the graphics processor.

Tools available for the development of GPGPU-compatible programs are above all “Open Computing Language” (OpenCL) and “Compute Unified Device Architecture” (CUDA).

OpenCL is an open standard that is available on many platforms, while CUDA is a proprietary “framework” by Nvidia™ and can only run on that manufacturer's GPUs. To execute programs on a GPU, one needs a host program to control the flow of information. The GPGPU code formulated in a C-type language is usually compiled during run time on instructions from the host program and sent for further processing to the graphics processor, which then returns the computed data to the host program.

According to a further embodiment of the inventive device, the at least one optical recording unit is an optical camera.

According to a further embodiment of the inventive device, the at least one optical camera is a line camera.

According to a further embodiment of the inventive device, the evaluation and control unit operates a plurality of optical recording units simultaneously.

According to a further embodiment of the inventive device, the latter comprises at least one frame grabber for data acquisition and preprocessing of data of the at least one optical recording unit. The frame grabber is a hardware component used to trigger the at least one camera or optical recording unit. In case of triggering by the processor, there is a loss of quality of the generated image at high sampling frequencies. The advantage of the aforementioned frame grabber, as compared with triggering by the processor, is that there are no delays due to processes executed in parallel and/or that these are avoided.

According to a further embodiment of the inventive device, the at least one container to be inspected, and which has a feature to be inspected, moves along a traverse path that resembles the traverse path for generating the feature to be inspected.

According to a further embodiment of the inventive device, the at least one optical recording unit and a movement of the container in the device are synchronized.

According to an embodiment of the inventive method, for the inspection of containers, image data of at least one container to be inspected is first captured as actual images by way of at least one optical recording unit of an inspection unit, and sent to an evaluation-and-control unit of the inspection unit, which then compares the actual images with desired images. The evaluation-and-control unit comprises at least one main processor and at least one graphics card, with a comparison being made of actual with desired images on the at least one graphics card, and with calculations associated with the comparison being effected in parallel by at least two graphics processors of the graphics card, and with the graphics card sending the evaluated data to the at least one main processor. The main processor then sends the evaluated data to a central controller that is connected to a handling/rejection unit.

In a further embodiment of the inventive method, actual images and desired images, in particular image formats of different image dimensions, are matched, in particular one-dimensionally, as well as two-dimensionally stretched, compressed, displaced, equalized, distorted, and subsequently superimposed.

In an embodiment of the inventive method, color values of actual images are determined and learned by the evaluation and control unit, and desired color values are converted to actual color values. The background to this is that by converting the RGB to CMYK image data, the color space of the original image is corrupted. The color space is also corrupted by reading in the image data by means of an optical recording unit while using at least one lighting unit, in particular one that uses white LED standard light. It is therefore an advantage if the system generates conversion rules of actual and desired color values.

In an embodiment of the inventive method, hue processing is applied on actual and desired images for color offset detection.

In an embodiment of the inventive method, actual images and desired images are divided up into a grid and one or more grid elements of the actual image are each compared with the analog grid element/elements of the desired images by one of the at least two graphics processors of the graphics card.

A further aspect of the invention is a computer program product with program code means which are stored on a computer-readable data medium in order to perform all steps of the method described herein when the computer program is executed on a computer or corresponding central processing unit.

A further aspect of the invention is the use of the inventive method in which the direct printing of a container is inspected immediately following the printing process.

It goes without saying that the features set out above and still to be explained below can be used not only in the indicated combination as the case may be but also in other combinations or in isolation without departing from the scope of the present invention.

Further details and advantages of the invention arise out of the following descriptions of embodiments of the invention and the corresponding drawing.

The invention is schematically represented by an embodiment example and two drawings, and is described in detail below with reference to the drawings.

### BRIEF DESCRIPTION OF THE DRAWINGS

FIG. 1 schematically depicts the layout of a direct printing machine.

FIG. 2 schematically depicts an embodiment of an inventive inspection unit.

### DETAILED DESCRIPTION

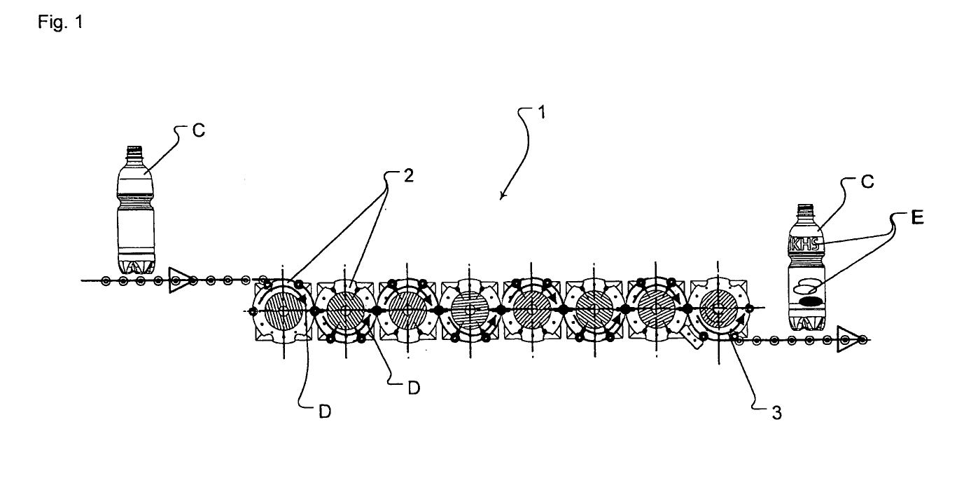

A direct printing machine 1 of, for example PET bottles C, shown in FIG. 1, comprises a plurality of star-shaped modules 2, which usually each represent one direct printing unit per color, an application of a handling fluid or special handling step, such as for example final drying and/or curing of the applied fluids, with each module 2 performing one or a plurality of functions. Arrows D indicate the direction of circulation of the modules 2. After each operation of a module 2, the bottle is transferred to a corresponding subsequent module 2 for further processing and/or printing. A direct printing machine 1 can thus be represented as a chain of star modules 2. The final module in this chain, which is also configured as a star module, is an inspection module 3. It is also possible for a plurality of inspection modules 3 to be provided inside the direct printing machine.

The design of the individual modules 2 in star format facilitates a “just-in-sequence” processing of the bottles. Each star module 2 has up to twelve pockets, in each of which one bottle is received and conveyed in the bottle transport direction, i.e. in the direction indicated by the arrow. In this way the handling process can be carried out in a pipelined or partially parallelized manner.

Although a star module 2 is seen to rotate by an outside observer, the twelve pockets are inside a static reference system relative to the received bottle. This facilitates highly accurate processing of the kind necessary for both printing and inspection.

The inspection module 3 acts autonomously in the analysis and evaluation of labels of directly printed bottles. Output to a control monitor and/or to a user interface of the whole machine is also possible. Likewise, recordings of defects can be stored on a server, for example, for documentation purposes. The inspection module 3 is in communication with an appropriate display unit and storage unit for this purpose.

The inspection module 3 is designed as a star having up to twelve pockets, each containing an inspection unit. Since stop-and-go operation with a machine output of 36,000 bottles/hour is not possible directly downstream of a stretch-blow machine without a buffer, the star shape is suitable for inspecting up to twelve bottles in parallel. On the inspection module 3, the inspection units follow the respective associated bottle in the transport direction, thereby facilitating the necessary inspection time.

To this end, each bottle is fed to the inspection module 3 via a puck and entrained for approximately 270°. For a star that rotates at 60 rpm, the bottle is therefore in the inspection module 3 for 0.75 seconds, which corresponds to the total time of the inspection process.

Although the inspection module 3 is seen to rotate by an outside observer, the received bottles and the associated inspection units are inside a static reference system. This makes it possible to read the bottle with the directly printed label without blurring, as would be the case, for example, with bottles moving past a camera system.

Each of the twelve pockets of inspection module 3 contains an inspection unit. An inspection unit reads the directly printed label on the associated bottle and stores it for further processing on a storage unit present in the inspection unit.

In order to be able to integrate inspection module 3 into the overall process of the direct printing machine, the output must be matched to the parameters of the machine as a whole, such as for example the bottle throughput, interfaces between individual modules, bottle handling and quality standards.

After the bottle has been fed to direct printing machine 1, it is transported and aligned by a puck. This puck travels with the bottle through all star modules 2 of the direct printing machine 1. The puck also serves as a rotary bottle drive for the all-round printing, all-round curing, and all-round measuring of the printed labels.

As soon as the puck is received into an inspection unit of the inspection module, the label can be digitized by an optical recording unit to yield data representing an actual image. This optical recording unit can be an optical camera, in particular a line camera. The use of a line camera, which reads the surface of the bottle line-by-line, minimizes distortion and blurring when reading the label. To this end, the puck that is guiding the bottle rotates before the recording camera.

In one variant, which is not shown, a printed image E is generated on a printing machine with which several or all colors and fluids are applied on a circulating star wheel or accompanying carriage. In this case, the inspection module 3 is arranged and operated in a manner analogous to the described device and/or method.

In order for the label of the bottle to have already been read over its entire periphery after 0.5 seconds, i.e. after half a rotation of the star module, the puck must rotate at a rotational speed that is greater than 2 rpm.

Another important point is the required resolution of the actual image. A possible print head, XAAR 1001, prints with a dot density of 36 dpi, which is equivalent to a dot pitch of 70.5 micrometers. Therefore the ability to read in a label that is, for example, 70 mm high requires, for example, a color line camera with a resolution of at least 1,365 pixels per line.

This and higher resolutions are indispensable for error detection in the printed image. For example, isolated failing print jets already lie within the range of 70.5 micrometers with a print resolution of 360 dpi.

Based on a 70-millimeter high label, the maximum resolution gives a dot pitch of 51.3 micrometers, so individual printed dots are detected. A maximum sampling frequency of 14 kHz makes it possible to read the label in 7,000 lines in half a star module rotation (f_{read}=0.5 seconds). The result is therefore a maximum effective image resolution of 1,365×7,000 pixels even when using a line camera with low resolution. A resolution of 1,024×2,250 pixels is sufficient if only defects that are clearly visible to the human eye are to be detected.

The data quantities generated per image of 14.33 MB in 0.5 seconds are transferred over a Gigabit Ethernet connection, for example GigE Vision, to a processor contained in the inspection unit because a very high data rate (R=28.67 MB/second) is required for this. Once this is completed, the flat actual images of the printed label are available for image processing.

To ensure synchronization between the line camera that is used and the rotary motion of the bottle, a microcontroller that triggers the line camera receives its impulses from an encoder of the bottle drive in the respective puck. This ensures that a further line of the label is read with each iteration step of the bottle rotation. In addition, a frame grabber can be used as a hardware component that triggers the deployed camera independently of the processor.

Errors that can occur in the printing process include for example fouling, scratching caused by friction between bottle and machine parts, offset of a print color, failure of individual print head jets, and total failure of individual print heads. These may be systematic errors, for example errors caused by incorrect setting, or they may be randomly occurring errors.

A direct printing application must also respond to the demand for constantly changing print images/motives. A regular inspection unit that is taught one format/design cannot be used in this case. It is necessary to compare the digitized image of the digital print with its source file.

The following methods and algorithms can be used to detect the possible errors.

In overlaying, the read-in flat image of the printed label, i.e. the actual image, is compressed to the size of the source file and overlaid on it. Large disparities such as, for example, fouling or heavy scratches and stress marks are obtained by subtraction.

In hue processing, a certain contained color is emphasized. Thus the actual image that is to be inspected can be broken down into its color components, such as cyan, magenta, yellow, and b/w. Color offset between individual color components can be detected in this way.

Pattern recognition is useful for finding isolated failing jets in the print head, which manifest themselves by a thin line in the printed image. Such errors can be identified by pattern recognition algorithms and an overlay of the actual image with the reference image, or desired image, so that lines not contained in the actual image are detected as errors.

Image processing involves the frequent calculation of many large matrices, with the size of the matrix corresponding to the image dimensions in pixels, divided into red, green, and blue. Many of these calculation operations are carried out element-by-element and so can be pipelined.

With the aid of CUDA technology, for example, it is possible to swap out calculations and programs to a graphics card and execute them there in parallel on a multiprocessor system. Today's graphics cards contain several hundred to several thousand multiprocessors capable of performing parallel calculations. These significantly reduce calculating time.

An element-by-element execution of an instruction, for example a subtraction for differentiation, requires nested iterations on a CPU 2877000 instructions that are executed sequentially. With a modern processor, for example an Intel™ Core i7 980XE with 107,55 GFLOPS (109 floating-point operations per second), the result for this alone is a theoretical computing time of 26 microseconds, not counting processes running on the CPU in parallel.

If this calculation is swapped out to a graphics card with, for example, 480 graphics processors, then the image to be processed is broken down into a grid, which corresponds to the number of available graphics processors. These then each execute one instruction in parallel with other processors, such that each graphics processor must execute 5,994 instructions. With a performance of 1.03 TFLOPS (trillion floating-point operations per second), the theoretical computing time is 2.793 microseconds.

Not every operation can be effectively swapped out to the graphics card's multiprocessor system. For example, for those processes that must be executed sequentially, the performance on the CPU is substantially better. This is why CUDA technology allows co-processing between CPU and GPU.
The work sequences can be differently assigned.

On the one hand, work sequences can be processed sequentially. After the bottle is received into the inspection module (Uₛₜₐᵣ=1.0 seconds), in the first 500 milliseconds the label on the printed bottle is read and stored in the graphics memory (frame buffer) of the graphics card (GPU). There are then a further 250 milliseconds available for image signal processing, comprising compressing, formatting, pattern recognition. This gives a process time of 750 milliseconds per inspection unit.

On the other hand, work sequences can be processed in parallel, i.e. pipelining. After a bottle is received into the inspection module, the bottle is read in the full transport time of 750 milliseconds. With pipelining, a further bottle is already being scanned while the image processing of the previous bottle is being carried out in parallel. A time of 1,250 milliseconds is available for this. The result is a process time per inspection unit of 2,000 milliseconds. Which process is more suitable depends on the time required for data acquisition and the image processing by the respective overall machine.

The result of the image evaluation can subsequently be output via a sliding contact by way of an Ethernet or VGA port to a user interface of the overall machine or to control monitors. Detected errors can by and large be traced to particular causes. This enables these errors to be treated individually. The response to these errors will depend both on the type of the error and on the machine design and on the bottle handling of the overall machine.

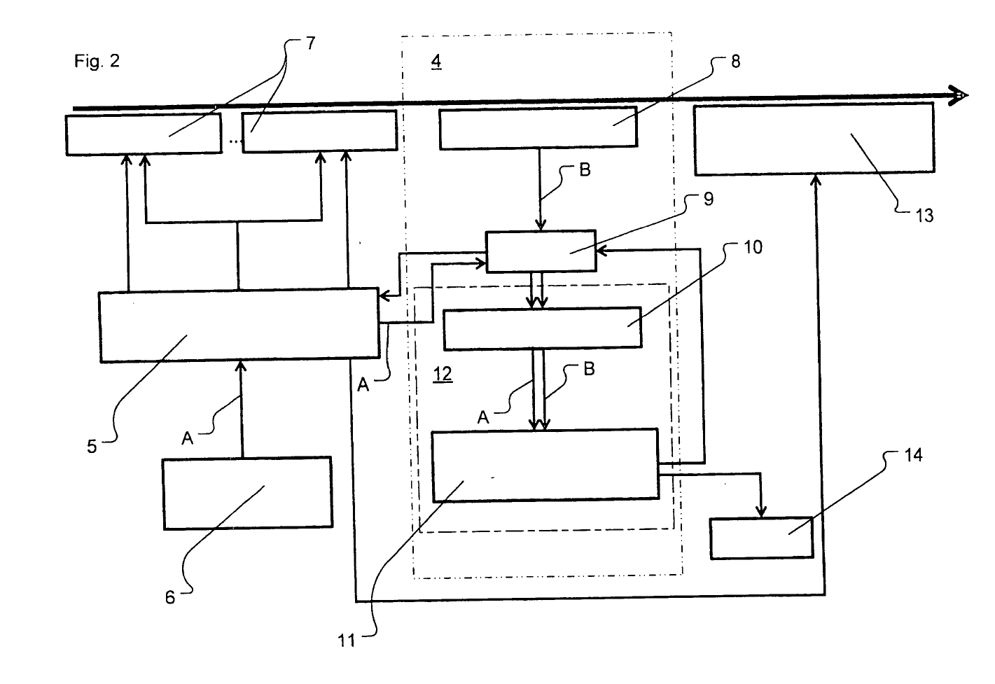

FIG. 2 summarizes the features of the inventive inspection unit 4. A central controller 5 of a direct printing installation is connected to an image memory 6 containing desired images A. The central controller 5 also controls a print module 7 for the direct printing of containers, for example bottles. After the printing process, a printed bottle enters the inspection unit 4. Within the inspection unit 4, an RGB line camera 8 first takes an actual image B of the bottle and sends it to a main processor 9 of the inspection unit 4. Via an image memory 10, the latter then sends actual image B from the line camera 8, together with the corresponding desired image A from the central controller 5, to a multiprocessor system 11 of the graphics card 12, where the actual image B and the desired image A are evaluated and compared. The outcome of the evaluation is then sent to the main processor 9 and onward to the central controller 5 that, depending on the outcome of the evaluation, releases the inspected bottle for further handling or removes it from the production line through a corresponding signal to a rejection unit 13. The inspection unit 4 is also connected via the graphics card 12 to a display 14.

Inspection unit 4 can be provided for example with a powerful central processor that is carried on the star module at 60 rpm. Or alternatively, each pocket can be provided with an on-board processor.

As an inexpensive alternative, one or more central processors could be arranged outside the rotary module, provided data transmission is appropriate.

The advantages of the inventive inspection module over conventional concepts can be summarized as follows:

The development of a star-shaped inspection module for inspecting directly printed three-dimensional objects offers a number of advantages. One inspection module contains a plurality of inspection units that are able to process inspection objects captured (partly) in parallel as the printed image is being generated (pipelining). This makes for a very high machine output, optimal utilization and a longest possible processing time.

Inspection units that are present in the inspection module create a static reference system relative to the containers that are to be inspected because they too move along in the transport direction of the inspected objects. As a result, the machine concept gains the precision necessary to detect production errors with a dot density of up to 600 dpi and more.

The object transport and logistics in the inspection module correspond to the transport and logistics in the printing process. As a result, the line camera will behave analogously to a print head. Instead of generating a printed image, the line camera reads in a digital map of the printed image. In this way, every object shape that can be directly printed is inspected in an identical traverse path. The aspect of traceability is also offered, in order to be able to remove bottles detected as faulty from the process at any desired time.

Image data is generated preferably using a line camera. It provides independence for the design of directly printed objects in regard to image distortion, depth of focus and the above-mentioned analogy with print head positioning. Any object that is industrially directly printed can therefore be inspected.

By way of graphics card programming, calculations of industrial image signal processing can be swapped out to multiprocessor systems of the graphics card and pipelined. A speed optimization occurs that is necessary for a short processing time brought about by a high machine output. Thus image data can, for example, be read and processed in under 0.75 seconds.

Unlike conventional inspection units that inspect the correct positioning and orientation of labels, the inventive inspection module employs the inventive method to also inspect the printed image itself for production errors in the printing. This innovation ensures a comprehensively correctly applied and directly printed label. The direct printing technique also facilitates a change of layout from object to object. An inspection unit can reference read print images to its source files.

1-15. (canceled)

16. A method for processing a container, said method comprising inspecting said container, wherein inspecting said container comprises using an optical recorder of an inspection unit, capturing image data of said container, said image data being representative of actual images, sending said image data to an evaluation and control unit of said inspection unit, said evaluation and control unit comprising a main processor and a graphics card having graphics processors, using said graphics card of said inspection unit, comparing said actual images with desired images, wherein comparing said actual images with said desired images comprises using said graphics processors for pipelining calculations associated with said comparison, and using said graphics card, sending evaluated data representative of said comparison to said main processor.

17. The method of claim 16, wherein comparing said desired images and said actual images comprises further comprises, on said graphics card, performing said calculations in parallel using at least 100 graphics processors of said graphics card.

18. The method of claim 16, wherein said actual images and said desired images have different image dimensions, and wherein said method further comprises matching said actual and desired image and overlaying said actual and desired images, wherein matching comprises at least one of stretching, compressing, displacing, equalizing, and distorting.

19. The method of claim 16, further comprising causing said evaluation and control unit to determine color values of said actual images, and causing conversion of desired color values to said actual color values.

20. The method of claim 19, further comprising detecting color offset between said actual and desired images, wherein detecting color offset comprises applying hue processing to said actual and desired image.

21. The method of claim 16, further comprising, using said graphics processors, dividing said actual and desired images as a grid, and comparing grid elements of said actual image with analogous grid elements of said desired image.

22. The method of claim 16, further comprising directly printing on a container prior to inspecting said container.

23. An apparatus for inspecting containers, said apparatus comprising a storage module, an optical recording unit, and an evaluation-and-control unit, wherein said storage module stores desired images, wherein said optical recording unit generates actual images, wherein said evaluation-and-control unit comprises a main processor and a graphics card, wherein said graphics card comprises graphics processors, and wherein said graphics card is configured to support graphics card programming for the swapping out calculations associated with a comparison of said actual and desired images to said graphics processors.

24. The apparatus of claim 23, wherein said optical recording unit comprises an optical camera.

25. The apparatus of claim 24, wherein said optical camera comprises a line camera.

26. The apparatus of claim 23, further comprising an additional optical recording unit, and wherein said evaluation-and-control unit is configured to serve plural optical recording units simultaneously.

27. The apparatus of claim 23, further comprising a frame grabber for capturing data from said optical recording unit and preprocessing said data.

28. The apparatus of claim 23, further comprising a traverse path that resembles a traverse path for generating a feature on a container that is to be inspected.

29. The apparatus of claims 23, wherein said optical recording unit is synchronized with movement of said container to be inspected.

30. A manufacture comprising a non-transitory computer readable medium having encoded thereon software for causing a particular machine to process containers, said software comprising instructions for causing said particular machine to execute steps of causing an optical recorder of an inspection unit to capture image data of said container, said image data being representative of actual images, sending said image data to an evaluation and control unit of said inspection unit, said evaluation and control unit comprising a main processor and a graphics card having graphics processors, using said graphics card of said inspection unit, comparing said actual images with desired images, wherein comparing said actual images with said desired images comprises using said graphics processors for pipelining calculations associated with said comparison, using said graphics card, sending evaluated data representative of said comparison to said main processor.
